(19) United States
(12) Patent Application Publication
(10) Pub. No.: US 2025/0192495 A1
(43) Pub. Date: Jun. 12, 2025

(54) COMPACT U-SHAPED HIGH-CAPACITY ADAPTER AND CONNECTOR SYSTEM

(71) Applicant: HARTING ELECTRIC STIFTUNG & CO. KG, Espelkamp (DE)

(72) Inventors: Chuan Sheng DING, Zhuhai (CN); Denny HELLIGE, Bad Oeyenhausen (DE)

(21) Appl. No.: 18/728,024

(22) PCT Filed: Jan. 4, 2023
(86) PCT No.: PCT/DE2023/100003

§ 371 Date: Jan. 27, 2025

(30) Foreign Application Priority Data
Jan. 12, 2022 (CN) 202210030224.1

(51) Int. Cl. H01R 31/06; H01R 13/512; H01R 13/52; H01R 13/627; H01R 13/629

(52) U.S. Cl. CPC H01R 31/06; H01R 13/5202; H01R 13/6272; H01R 13/629; H01R 13/512

(57) ABSTRACT

A compact U-shaped high-performance adapter is provided including a first sub-adapter and a second sub-adapter arranged in parallel, wherein a mounting space within the first sub-adapter is connected to a mounting space within the second sub-adapter to form a common mounting space, wherein the common mounting space receives a contact carrier, and wherein at least one U-shaped contact is received in the contact carrier. A connector system having a high-performance adapter and two plug connectors is also provided. The high-performance adapter has a compact design and can implement the power transfer from one plug connector to the other plug connector.

### BACKGROUND

### Technical Field

The present disclosure relates to the technical field of connectors, in particular a compact U-shaped high-performance adapter and a connector system having the compact U-shaped high-performance adapter.

### Description of the Related Art

For connectors, in particular industrial plug connectors, the most compact installation space possible is desired along with a relatively large functional scope. However, existing plug connectors usually only implement the electrical connection between a single plug connector and a single adapter and have a single function.

### BRIEF SUMMARY

Embodiments of the present disclosure aim to provide a compact high-performance adapter (adapter) and a connector system having the same, wherein the adapter has a compact design and can implement power transfer from one plug connector to another plug connector and is thus suitable for high-current/high-voltage applications, wherein the adapter can also offer a connection with ingress protection rating IP68/69.

A first aspect of the present disclosure provides a compact U-shaped high-performance adapter (adapter), including a first subadapter and a second subadapter arranged in parallel, characterized in that a mounting space within the first subadapter is connected to a mounting space within the second subadapter to form a common mounting space, wherein the common mounting space accommodates a contact carrier, and wherein at least one U-shaped contact is accommodated in the contact carrier.

In an advantageous embodiment, one leg of the U-shaped contact may be designed as a male contact, and the other leg may be designed as a female contact. The male contact and the female contact may be connected to one another by a conductive connection portion.

In an advantageous embodiment, the contact carrier may include: a main body, wherein at least one pair of a male contact receptacle and a female contact receptacle is formed on the main body in order to receive the male contact and the female contact of the U-shaped contact; and a cover, which is used to enclose the U-shaped contact in the contact carrier. In some embodiments, the main body may be designed with two, three, four or another number of pairs of male contact receptacles and female contact receptacles.

In an advantageous embodiment, the first subadapter and the second subadapter may each have a rectangular housing, wherein the housings each have polygonal projections on the top in order to surround the corresponding mounting space, and wherein the male contact receptacle and the female contact receptacle each protrude out of the mounting space of the first subadapter and the mounting space of the second subadapter and beyond the polygonal projections. In other embodiments, the male contact receptacle and the female contact receptacle may each protrude out of the mounting space of the second subadapter and the mounting space of the first subadapter.

In an advantageous embodiment, the polygonal projections may be provided on the outer side walls with a polygonal seal slot for attaching a seal ring. When the adapter is plugged onto the plug connector, the outer side wall of the polygonal projection acts as a contact surface, wherein the seal ring surrounds the contact surface in order to achieve the watertight rating IP68/69.

In an advantageous embodiment, the housings may each have two wide sides and two narrow sides, wherein the narrow sides each have mounting portions in which threaded bores are formed, by which the first subadapter and the second subadapter are fastened to one another by a screw. In other embodiments, the first subadapter and the second subadapter may be fastened by, for example, a snap connection, a hinged connection, etc.

In an advantageous embodiment, one of the two wide sides may have an opening for inserting the contact carrier, wherein the inner wall of the other wide side is provided with an upper stop and a lower stop for latching in the contact carrier, and an arcuate guiding portion for guiding the contact carrier for movement within the mounting space during assembly.

A further aspect of the present disclosure provides a connector system including an above compact U-shaped high-performance adapter (adapter) and two plug connectors, wherein the two plug connectors are each plugged onto the first subadapter and the second subadapter.

In an advantageous embodiment, one of the two plug connectors may have at least one male contact, and the other may have at least one female contact, in order to form an electrical contact with the U-shaped contact of the adapter, as a result of which the power transfer between the two plug connectors is implemented.

Because a plug connector with a male contact, namely a male connector, and a plug connector with a female contact, namely a female connector, are plugged simultaneously into the adapter with the U-shaped contact, a current-carrying circuit can be formed from the male contact of the male connector, the female contact of the U-shaped contact of the adapter, the male contact of the U-shaped contact, and the female contact of the female connector, in order to implement a high-current/high-voltage power transfer between two plug connectors.

### BRIEF DESCRIPTION OF THE SEVERAL VIEWS OF THE DRAWINGS

Embodiments of the present disclosure are shown in the drawings and explained in more detail below.

FIG. 1 shows a perspective diagram of an adapter according to an embodiment of the present disclosure.

FIG. 2 shows a perspective diagram of an adapter without a contact carrier according to an embodiment of the present disclosure.

FIG. 3 shows a perspective diagram of a contact carrier according to an embodiment of the present disclosure.

FIG. 4 shows a perspective diagram of a U-shaped contact according to an embodiment of the present disclosure.

FIG. 5 shows a view from above of the adapter according to an embodiment of the present disclosure.

FIG. 6 shows a sectional view of the adapter according to FIG. 5 along line A-A.

FIG. 7 shows a front view of the first subadapter equipped with a contact carrier according to an embodiment of the present disclosure.

FIG. 8 shows a side view of the first subadapter equipped with the contact carrier according to an embodiment of the present disclosure.

FIG. 9 shows a sectional view of the first subadapter equipped with the contact carrier according to FIG. 7 along line B-B.

FIG. 10 shows a perspective diagram of a first subadapter equipped with the contact carrier according to an embodiment of the present disclosure.

FIG. 11 shows a perspective diagram of a connector system according to an embodiment of the present disclosure.

FIG. 12 shows an exploded view of a connector system according to an embodiment of the present disclosure.

FIG. 13 shows a view from below of two plug connectors of the connector system according to an embodiment of the present disclosure.

FIG. 14 shows a perspective diagram of an adapter according to an alternative embodiment of the present disclosure.

FIG. 15 shows a perspective diagram of a connector system according to an alternative embodiment of the present disclosure.

FIG. 16 shows a view from below of two plug connectors of a connector system according to an alternative embodiment of the present disclosure.

### DETAILED DESCRIPTION

The present disclosure is explained in more detail below in connection with embodiments and figures. In the description, identical or similar reference signs may indicate the same or similar components. The following explanation of the embodiment of the present disclosure in connection with the figures is used to explain the overall concept of the present disclosure and is not to be understood as a limitation of the present disclosure.

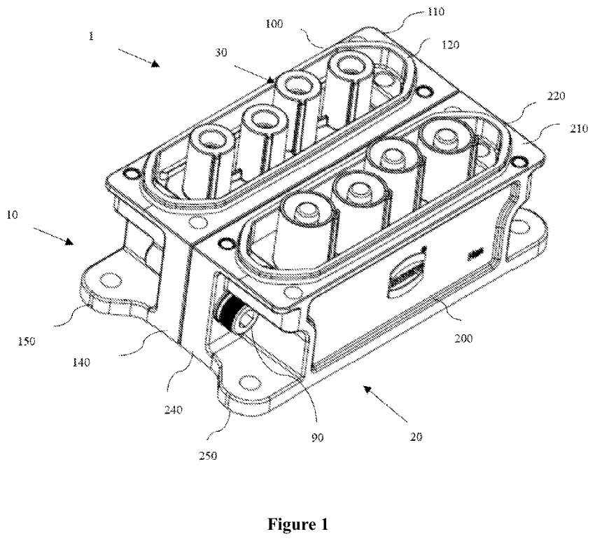

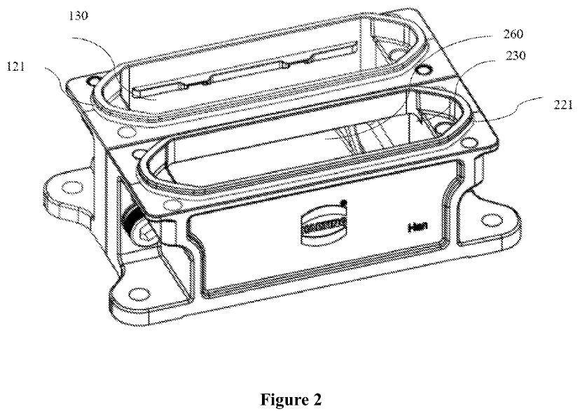

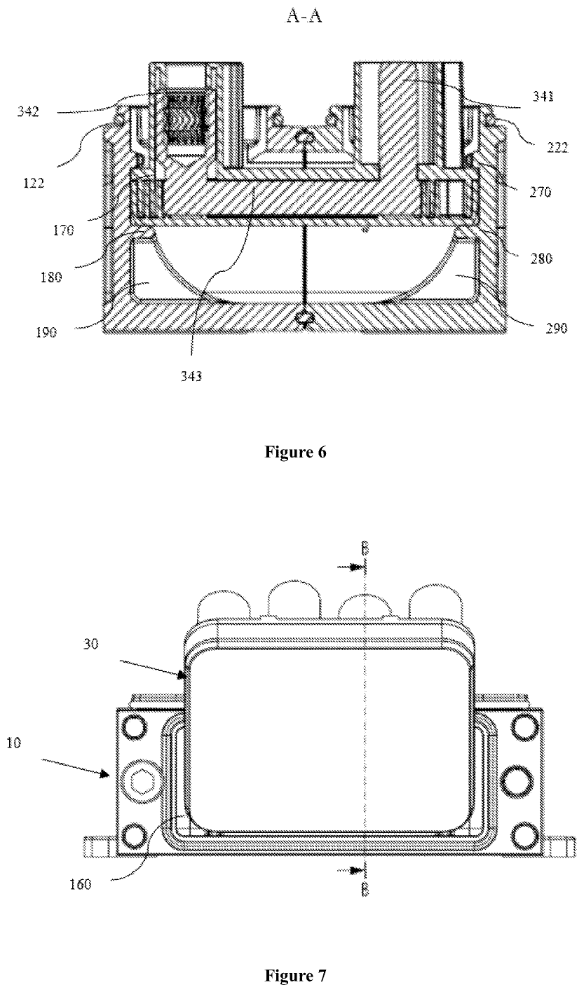

FIG. 1 shows a perspective diagram of an adapter according to an embodiment of the present disclosure, wherein the adapter is formed by two separate subadapters oriented parallel to one another, namely a first subadapter 10 and a second subadapter 20. The two subadapters 10, 20 each have a rectangular housing 100, 200. A person skilled in this field will understand that the shape is not limited to a rectangle but can be any other known shape, such as elliptical, oval, even square and the like. The housings 100, 200 each have rectangular flanges 110, 210 on the top, wherein a threaded bore is provided at four corner portions of the rectangular flanges 110, 210. Polygonal projections 120, 220 are formed in the center of the rectangular flanges 110, 210, wherein the projections are substantially ridge-like and project upward from the plane in which the rectangular flanges are situated. The polygonal projections 120, 220 surround the mounting space 130, 230 (shown more clearly in FIG. 2). On the other side wall of the polygonal projections 120, 220, a seal slot 121, 221 is formed, in which a seal ring 122, 222 (FIG. 6) is accommodated. On each of the two narrow sides (namely, the left-and right-hand sides according to FIG. 1) of the housings 100, 200, such as at an end of each narrow side, mounting portions 140, 240 are formed (only the mounting portion on one narrow side is shown in FIG. 1), wherein the mounting portions 140, 240 are designed as ridges for connecting the upper flanges 110, 210 and the lower flanges 150, 250 of the housings 100, 200, and wherein a threaded bore is formed in the mounting portions 140, 240, and wherein the two subadapters are fastened to one another by one screw 90 passing through the threaded bores of the mounting portions 140, 240 of the two subadapters 10, 20. A person skilled in this field will understand that the two subadapters can be connected to one another by other methods such as a snap connection, a hinged connection, etc. A threaded bore is formed in the lower flanges 150, 250 of the housings 100, 200 to fasten the adapter 1 to the wall of the device, for example.

It can be seen in FIGS. 1 and 5 that a contact carrier 30 is accommodated in the mounting spaces 130, 230 of the housings 100, 200. FIG. 2 shows a perspective diagram of an adapter without a contact carrier according to an embodiment of the present disclosure. As shown in FIG. 2, the mounting spaces 130, 230 are connected to one another. FIG. 7 shows a front view of a first subadapter 10, wherein an opening 160 is formed on a wide side of the housing 110 of the first subadapter 10, namely on a wide side facing the second subadapter 20 when assembled. Correspondingly, an opening 260 (FIG. 2) is formed on a wide side of the housing 210 of the second subadapter 20, namely on a wide side facing the first subadapter 10 when assembled. In this way, the mounting spaces 130, 230 are connected to one another by the openings 160, 260. FIG. 6 clearly shows that the mounting spaces 130, 230 form a common mounting space to accommodate the contact carrier 30.

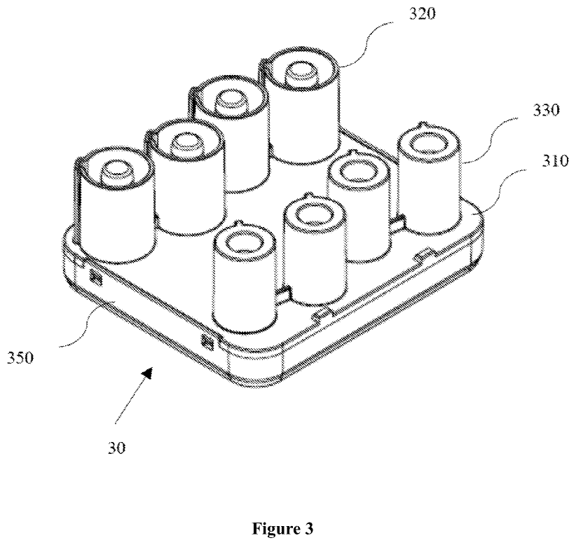

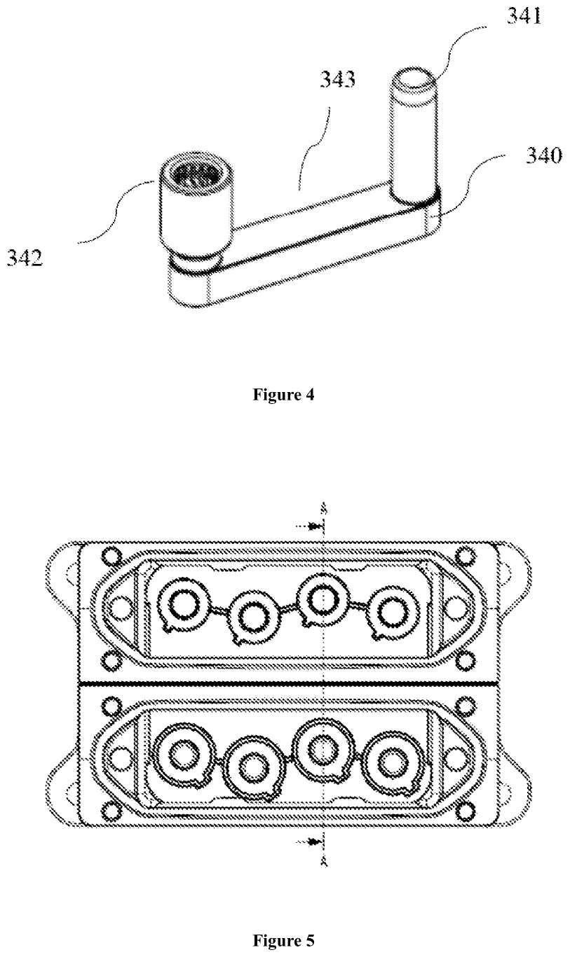

FIG. 3 shows a perspective diagram of a contact carrier according to an embodiment of the present disclosure. The contact carrier 30 comprises a rectangular or square main body 310 in which four pairs of male contact receptacles 320 and female contact receptacles 330 are formed in an integrated manner. A person skilled in this field will understand that one, two, three, four or another number of pairs of male contact receptacles and female contact receptacles can be formed in an integrated manner on the main body. It is also self-evident that the male/female contact receptacles can be formed on the main body by other methods such as threaded connections. The male contact receptacle 320 and the female contact receptacle 330 are each cylindrical, wherein the diameter of the male contact receptacle 320 is larger than the diameter of the contact receptacle 330. The contact carrier 30 also comprises a cover 350, which encloses the main body in order to form a receiving space for receiving the U-shaped contact. In FIG. 3, the cover 350 is connected to the main body by a snap connection. According to FIG. 5, the four male contact receptacles 320 are distributed offset from one another, and the four female contact receptacles 330 are likewise distributed offset from one another. That is, the contact receptacles are distributed on a line in order to facilitate insertion into the contact-receiving portions of the plug connector and removal therefrom. FIG. 4 shows a perspective diagram of a U-shaped contact 340 according to an embodiment of the present disclosure. The U-shaped contact 340 is U-shaped overall and comprises two legs, wherein one leg is designed as a male contact 341, and the other leg is designed as a female contact 341. The male contact 341 and the female contact 342 are connected to one another by a connecting portion 343, wherein the connecting portion is produced from conductive material. FIG. 6 shows that the male contact 341 of the U-shaped contact 340 is plugged into the male contact receptacle 320, and the female contact 342 is plugged into the female contact receptacle 330. The cover 350 is installed from below, in order to fasten the U-shaped contact 30 in the contact carrier 30, wherein the connecting portion 343 of the U-shaped contact 340 is situated between the main body 310 and the cover 350.

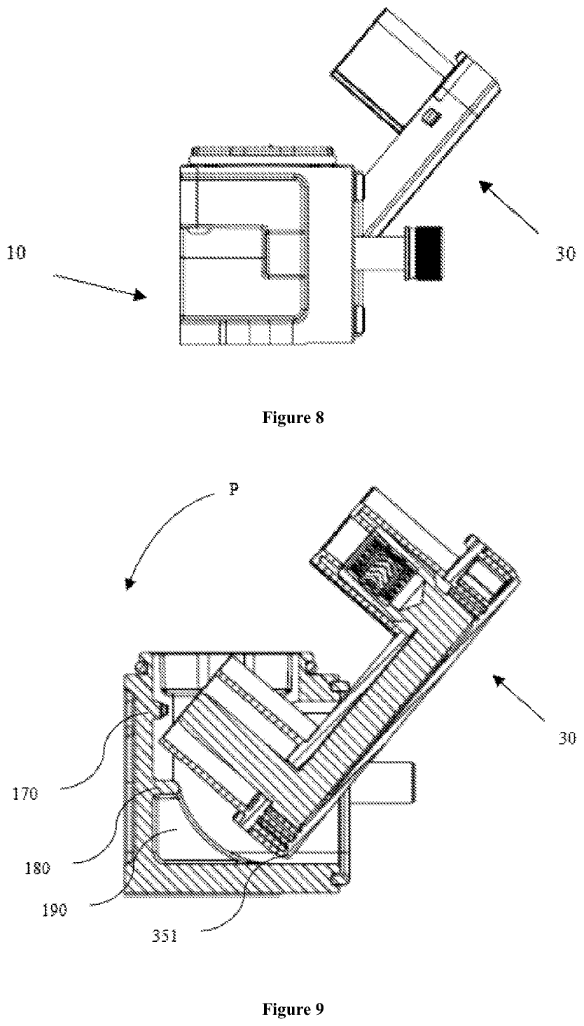

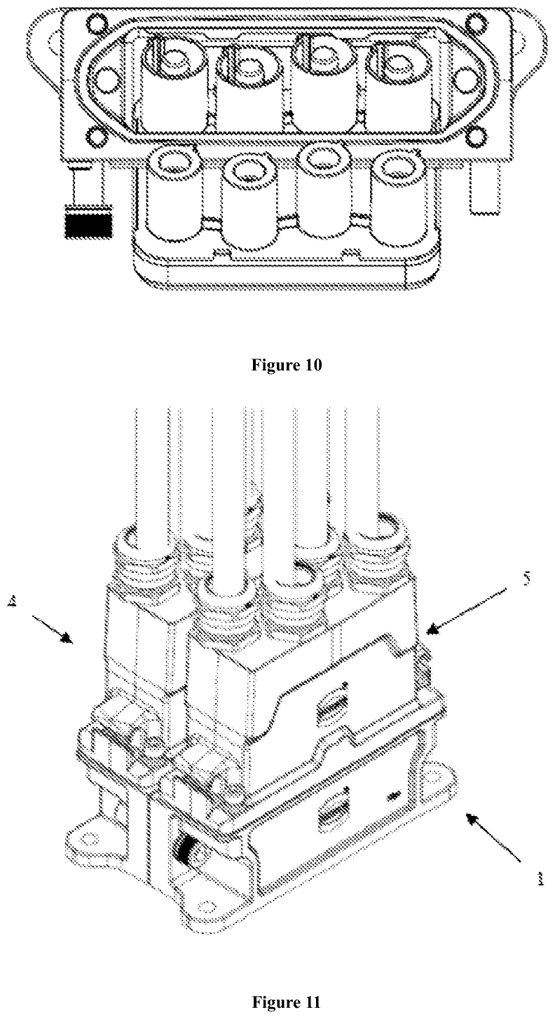

The process of assembling the contact carrier 30 in the first subadapter 10 is explained in more detail below in connection with FIGS. 7 to 10. First, the contact carrier 30 is tilted by a certain angle, i.e., rotated by a certain angle in the direction of the arrow P (FIG. 9), and then, for example, the male contact receptacle 320 of the contact carrier 30 passes through the opening 160 in the wide side of the first subadapter 10. The male contact receptacle 320 passing through the opening 160 is then rotated by a certain angle counter to the direction of the arrow P so that the male contact receptacle 320 protrudes out of the mounting space 130 of the first subadapter 10 beyond the polygonal projection 120. The contact carrier 30 then returns to its normal horizontal state. When the male contact receptacle 320 passes through the opening 160 in the first subadapter 10, the female contact receptacle 330 is likewise in its most inclined position, as shown in FIG. 9; the second subadapter 20 is then tilted, and its opening 260 is oriented toward the female contact receptacle 330 so that the female contact receptacle 330 passes through the opening 260. When the male contact receptacle 320 is rotated counter to the direction of the arrow P, the second subadapter 20 is also rotated so that the female contact receptacle 330 likewise protrudes out of the mounting space 230 of the second subadapter 20 and beyond the polygonal projection 220. When the first subadapter 10, the second subadapter 20 and the contact carrier 30 are each in the horizontal position shown in FIG. 1, the mounting of the contact carrier 30 in the adapter 1 is complete.

The specific rotation process is explained in more detail in connection with FIGS. 6 and 9. FIG. 6 shows that an upper stop 170, 270, a lower stop 180, 280 and an arcuate guiding portion 190, 290 are arranged on an inner wall of a wide side of the first subadapter 10 and the second subadapter 20 opposite the wide side provided with the openings 160, 260, wherein one end of the arcuate guiding portion is adjacent to the lower stop 180, 280, and the other end extends to the inner wall of the bottom of the housing of the first subadapter and the second subadapter. As shown in FIG. 9, when the male contact receptacle 320 passes through the opening 160 in the first subadapter 10, the contact carrier 30, such as the lower edge 351 of the cover 350 of the contact carrier, moves upward along the arcuate guiding portion 190 until the lower edge 350 reaches a position above the lower stop 180, as shown in FIG. 6. In this way, the contact carrier 30 is locked between the upper stop 170 and the lower stop 180 of the first subadapter 10. The lower edge of the cover is likewise guided, on the side where the female contact receptacle 330 is situated, along the arcuate guiding portion 290 of the second subadapter 20 until the contact carrier 30 is locked between the upper stop 270 and the lower stop 280 of the second subadapter 20. At the end, the fastening of the contact carrier in the first subadapter and the second subadapter is implemented.

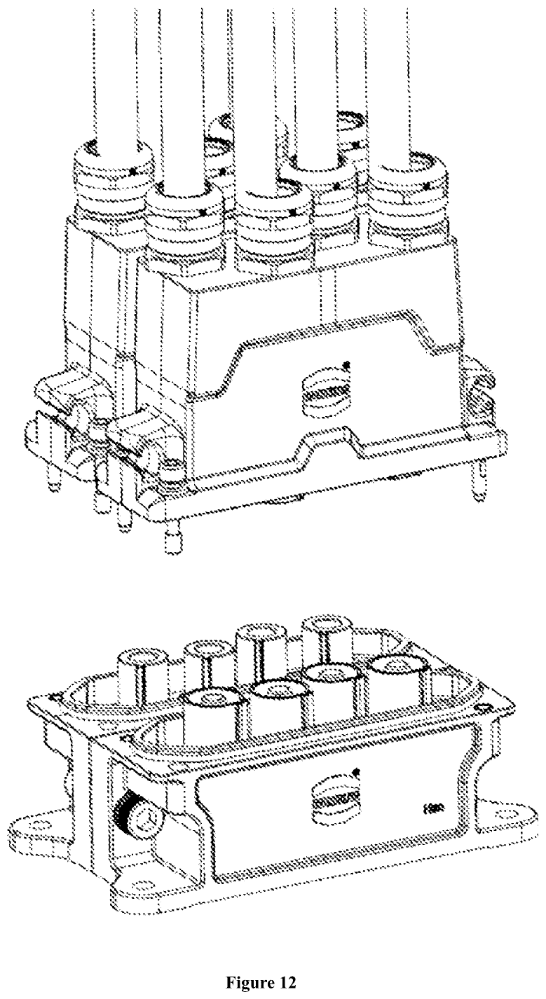

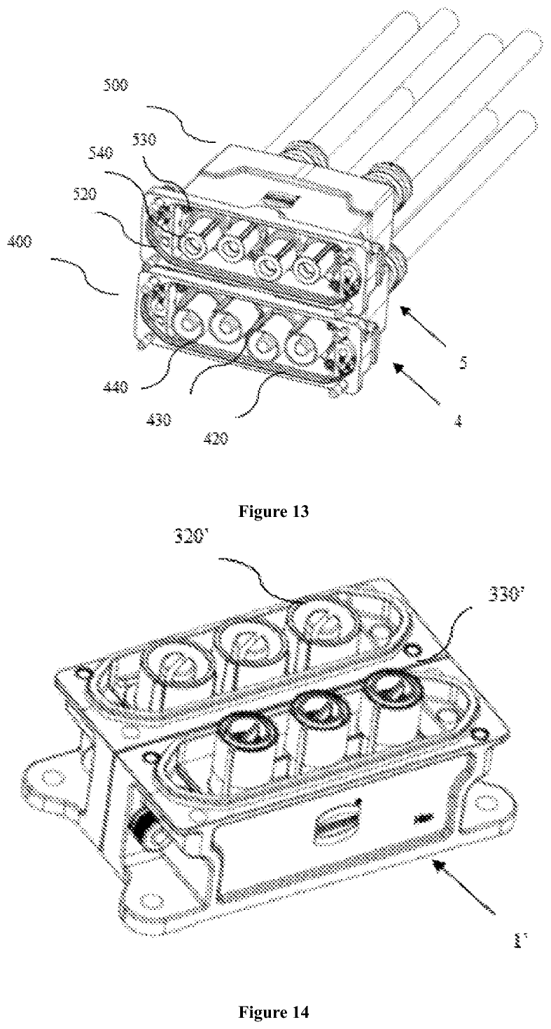

FIGS. 11 and 12 show a perspective diagram and an exploded view of a connector system according to an embodiment of the present disclosure. The connector system comprises an above adapter 1 and two plug connectors 4, 5. FIG. 13 shows a view from below of two plug connectors of a connector system according to an embodiment of the present disclosure, wherein the plug connectors 4, 5 each have a rectangular housing, wherein multiple cable connections are arranged on the top of the housing in order to connect multiple cables, and wherein polygonal slots 420, 520 are provided on the bottom of the housing, the shape of which slots corresponds to the shape of the polygonal projections 120, 220 of the adapter, and wherein a polygonal slot 420, 520 surrounds the mounting spaces 430, 530 in each case, and wherein male contact receptacles 440 and female contact receptacles 540 are accommodated in the mounting spaces 430, 530. As shown in FIG. 13, the plug connectors 4, 5 have four male contact receptacles and four female contact receptacles, respectively, wherein a male contact is accommodated in the male contact receptacle 440, and a female contact is accommodated in the female contact receptacle 540. A person skilled in this field will understand that the plug connector can have male contact receptacles and female contact receptacles in a number that corresponds to the number of pairs of male contact receptacles and female contact receptacles of the adapter. In the plug connection, the male contact of the plug connector 4 is plugged into the female contact receptacle 330 of the contact carrier 30 of the adapter 1 in order to form an electrical contact with the female contact 342, accommodated therein, of the U-shaped contact 340. The male contact 341 of the U-shaped contact 340 in the male contact receptacle 320 of the contact carrier 30 of the adapter 1 is plugged into the female contact receptacle of the plug connector 5 and forms an electrical connection with the female contact accommodated therein, as a result of which an electrical circuit is formed in order to implement power transfer from the plug connector 4 to the plug connector 5. In the plug connection, the polygonal projections 120, 220 of the adapter are also plugged into the polygonal slots 420, 520 of the plug connectors 4, 5, wherein the seal rings 122, 220 of the polygonal projections 120, 220 offer sealing between the outer wall of the polygonal projections and the inner wall of the polygonal slots, as a result of which the connector system achieves the watertight rating IP68/69.

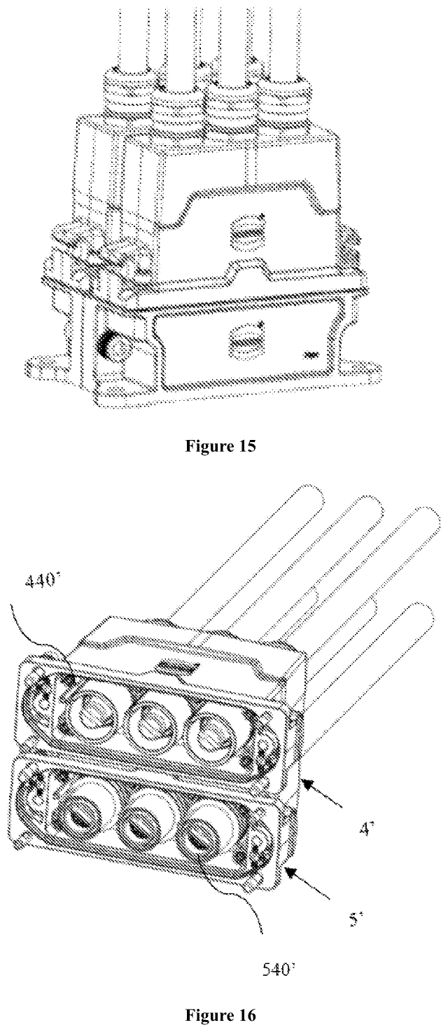

FIG. 14 shows a perspective diagram of an adapter in an alternative embodiment of the present disclosure. The difference between an adapter 1′ and the adapter 1 is that three pairs of male contact receptacles 320′ and female contact receptacles 330′ are formed in an integrated manner on the contact carrier of the adapter 1′. FIGS. 15 and 16 show a perspective diagram of a connector system in another embodiment of the present disclosure and a view from below of a plug connector. It can be seen in FIG. 16 that plug connectors 4′, 5′ have three male contact receptacles 440′ and female contact receptacles 540′ respectively in order to correspond with the three pairs of male contact receptacles and female contact receptacles of the adapter 1′.

A person skilled in this field will understand that the present disclosure is not limited to the details of the exemplary embodiments. Furthermore, the present disclosure can be implemented with other detailed embodiments. In addition, features of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A compact U-shaped high-performance adapter, comprising:
a first subadapter; and
a second subadapter arranged in parallel, wherein a mounting space within the first subadapter is connected to a mounting space within the second subadapter to form a common mounting space, wherein the common mounting space accommodates a contact carrier, wherein at least one U-shaped contact is accommodated in the contact carrier.

2. The compact U-shaped high-performance adapter as claimed in claim 1, wherein one leg of the U-shaped contact is designed as a male contact, and the other leg is designed as a female contact.

3. The compact U-shaped high-performance adapter as claimed in claim 2, wherein the contact carrier comprises a main body and a cover, wherein at least one pair of a male contact receptacle and a female contact receptacle is arranged on the main body in order to receive the male contact and the female contact, respectively, of the U-shaped contact, wherein the cover is used to enclose the U-shaped contact in the contact carrier.

4. The compact U-shaped high-performance adapter as claimed in claim 3, wherein the first subadapter and the second subadapter both have rectangular housings, wherein the housings each have polygonal projections on a top of the housings in order to enclose the corresponding mounting space, wherein the male contact receptacle and the female contact receptacle protrude out of the mounting space of the first subadapter and out of the mounting space of the second subadapter and beyond the polygonal projections.

5. The compact U-shaped high-performance adapter as claimed in claim 4, wherein the polygonal projections are provided on the outer side walls with a polygonal seal slot for attaching a seal ring.

6. The compact U-shaped high-performance adapter as claimed in claim 4, wherein the housings each have two wide sides and two narrow sides, wherein the narrow sides each have mounting portions in which threaded bores are formed, by which the first subadapter and the second subadapter are connected to one another by a screw.

7. The compact U-shaped high-performance adapter as claimed in claim 6, wherein one of the two wide sides has an opening for inserting the contact carrier, wherein an upper stop and a lower stop for latching in the contact carrier are arranged on an inner wall of the other wide side, and wherein a curved guiding portion is arranged on the inner wall in order to guide a movement of the contact carrier within the mounting space during mounting.

8. A connector system, comprising:
a compact U-shaped high-performance adapter as claimed in claim 1; and
two plug connectors, wherein the two plug connectors are plugged onto the first subadapter and the second subadapter of the compact U-shaped high-performance adapter.

9. The connector system as claimed in claim 8, wherein one of the two plug connectors has at least one male contact and the other plug connector has at least one female contact in order to produce an electrical contact with the U-shaped contact of the compact U-shaped high-performance adapter, wherein the transfer of energy between the two plug connectors is made possible.
